(19) United States
(12) Patent Application Publication
(10) Pub. No.: US 2026/0177214 A1
(43) Pub. Date: Jun. 25, 2026

(54) Customizable lighting system

(71) Applicant: ELITE LIGHTING, Commerce, CA (US)

(72) Inventor: Hamid Rashidi Doust, Beverly Hills, CA (US)

(21) Appl. No.: 19/085,373

(22) Filed: Mar. 20, 2025

Related U.S. Application Data
(60) Provisional application No. 63/736,330, filed on Dec. 19, 2024.

(51) Int. Cl. F21S 2/00; F21V 21/16; F21V 23/06; F21Y 113/00; F21Y 115/10

(52) U.S. Cl. CPC F21S 2/005; F21V 21/16; F21V 23/06; F21Y 2113/00; F21Y 2115/10

(57) ABSTRACT

Provided is a modular lighting system comprising: a modular housing with a top and sidewalls, and open ends in between the sidewalls; an LED board place inside of the modular housing; a plurality of LED light sources placed on the LED board, the LED light sources facing downwardly; and a lens placed below the LED board; wherein the housing is configured to attach to one or more additional modular housings to create a lighting fixture with two- or three-dimensional shape.

### CROSS-REFERENCE

The present application claims the benefit of application No. 63/736,330, filed on Dec. 19, 2024, which is incorporated herein by reference in its entirety.

### BACKGROUND SECTION OF THE INVENTION

LED (Light emitting Diode) lighting provides suitable lighting with maximal efficiency. There is a need in the art for LED light fixtures that are customizable to the desire of a user and to the size of a room.

### SUMMARY SECTION OF THE INVENTION

Provided is a modular lighting system comprising: a modular housing with a top and walls, and open ends; an LED board place inside of housing; a plurality of LED light sources placed on the LED board, the LED light sources facing downwardly; and a lens placed below the LED board; wherein the housing is configured to attach to one or more additional modular housings to create a lighting fixture with two- or three-dimensional shape. The modular housing can be triangular, with curved sidewalls and open ends between the sidewalls. The lighting system can comprise at least three modules, with two of the modules configured to be attached to the ceiling in a horizontal orientation. The module can be configured to attach the two modules to each other by having a curve and two straight ends. The module can have two internal compartments, above and below the LED board. The top of the housing can have an opening for attachment to a ceiling by a wire. The housing can have a track inside for attachment to a bracket. The end of one module can be connected to another end of another module in such configuration that edges of the two modules align. Compartments can form inside of the housing formed below and above the LED board continue from one module to another without presence of an end cap. The module can be configured to rest on a support to form a top of a table.

Provided is a modular light system comprising: a housing with a top, and two or more sidewalls; an LED board placed inside of the housing, the LED board creating an upper and a lower compartment; a plurality of LED light sources placed on the LED board in the lower compartment; one or more openings in between the sidewalls; a lens placed below the LED board for light to leave the lower compartment; and one or more plugs for carrying electricity to the LED board; wherein the module is configured to be attached to another module of same or different shape. The module can comprise a plug for making an electric connection. The module can comprise a track on inside of the sidewalls for receiving a bracket. The housing can be triangular, with three sidewalls and three openings at the ends in between the sidewalls. The triangular housing can be curved sidewalls, at least one of the curved sidewalls configured to form part of a circle. The triangular housing can have curved sidewalls, at least one of the curved sidewalls configures to form part of a circle. The housing can have a curved body with straight ends that are parallel to each other. The housing can have two ends, the two ends perpendicular to each other. The housing can be S, O, or U shaped.

Provided is a modular lighting system comprising: a housing with top, and two or more sidewalls; an LED board placed inside of the housing, the LED board creating an upper and a lower compartment; a plurality of LED light sources placed on the LED board in the lower compartment; one or more openings in between the sidewalls; a lens placed below the LED board for light to leave the lower compartment; one or more plugs for carrying electricity to the LED board; a plug for making an electric connection placed at one or more the ends; and a track on inside of the sidewalls for receiving a bracket; wherein the module is configured to be attached to another module of same or different shape.

### BRIEF DESCRIPTION OF THE DRAWINGS

FIG. 1 illustrates a bottom view of the triangular module containing LED lights.

FIG. 2 illustrates a top view of the triangular module containing LED lights.

FIG. 3 illustrates an LED board, with LED light sources thereon.

FIG. 4 illustrates the bottom view of the LED board.

FIG. 5 illustrates an exploded top-perspective view of the triangular module.

FIG. 6 illustrates an exploded bottom-perspective view of the triangular module.

FIG. 7a illustrates a mechanism for connection of two modules.

FIG. 7b illustrates a bracket with a stopper for connecting two modules.

FIG. 7c illustrates placement of a bracket inside of a module.

FIG. 8a illustrates a mechanism for connection of two modules.

FIG. 8b illustrates a bracket with a stopper for connecting two modules.

FIG. 8c illustrates placement of a bracket inside of a module.

FIG. 9 illustrates the SOUL lighting installed in a three-dimensional manner by connecting different modules together.

FIG. 10 illustrates the attachment of the module to a wire.

FIG. 11a illustrates the attachment of the module to a wire.

FIG. 11b illustrates the attachment of the module to a wire.

FIG. 11c illustrates the attachment of the module to a wire.

FIG. 11d illustrates the attachment of the module to a wire.

FIG. 11e illustrates the attachment of the module to a wire.

### DETAILED DESCRIPTION OF THE INVENTION

SOUL Essential Shapes—is a versatile Free-Form Shape LED luminaire that brings spirit, energy, and action to large space environments. SOUL harnesses the flexibility and creativity of a tape light while maintaining the quality and durability of a solid luminaire; designed to simultaneously enhance creativity and functionality in a space, this unique fixture comes in separate pieces which join to create various flowing, long running, free-form and round-edge shapes, including squares and rectangles, circles, ovals, and S, O, U, and L.

Available with surface mount, ceiling mount, suspended mount, and wall mounting options, in a standard width of 2.3″, in various lengths and angles that allow for playful design. Capable of maximum continuous runs of 16 feet and ideal for adding an element of originality to corporate offices, educational, commercial, and retail spaces.

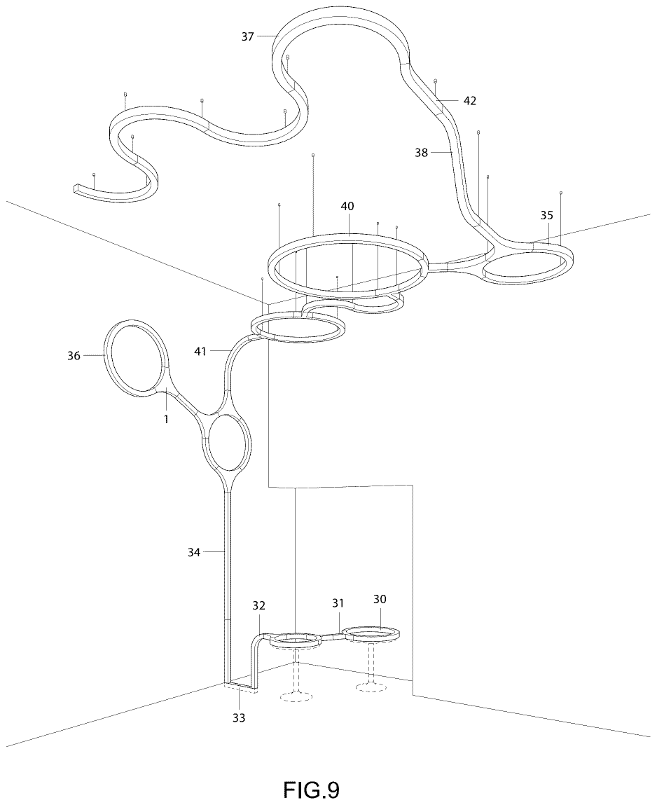

The lighting system can have modules in the shape of three-dimensional objects, such as a table (FIG. 9). The table can be circular with lighting all around the edge. The table can have a base or an extension module 32 on the side that comes to the ground. The lighting module can be designed to be placed on the ground and be suitable for walking upon. The lighting module can be three dimensional and change from the x-y plane to the z plane. The lighting modules can have transitional segments (modules 32, 38), that can be curved or straight and change the plane from the x-y to the z plane. The lighting modules can be suspended from the ceiling. There can be a segment of lighting module that is suspended from a ceiling and another segment attached to a vertical wall, with a transitional segment (module) connecting both together. The transitional segment, which can be a separate module, can be curved with part of the segment attached to the wall and other suspended from a ceiling. The lighting system can be made from different modules that are attached to each other with locking mechanisms. Each module can have a housing 1 (which can be opaque), a transparent or a translucent lens 2, LED sources of light 6, typically an LED board 5 with LED sources of light 6, and a locking mechanism for connecting the modules together. The module can be fabricated as a single component (such as from molded aluminum), or made from multiple components.

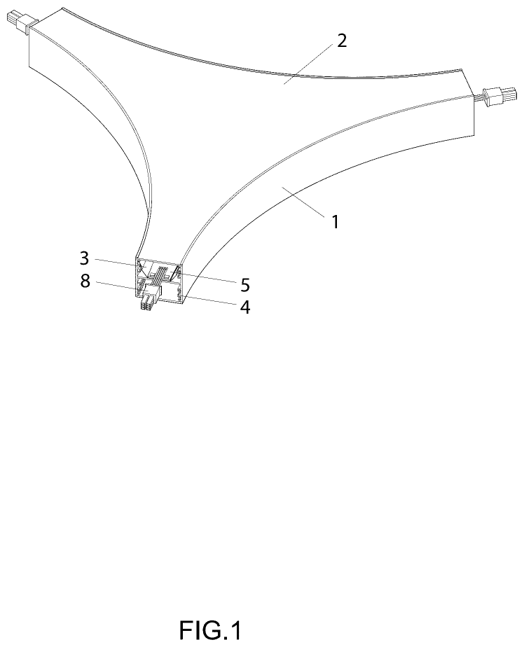

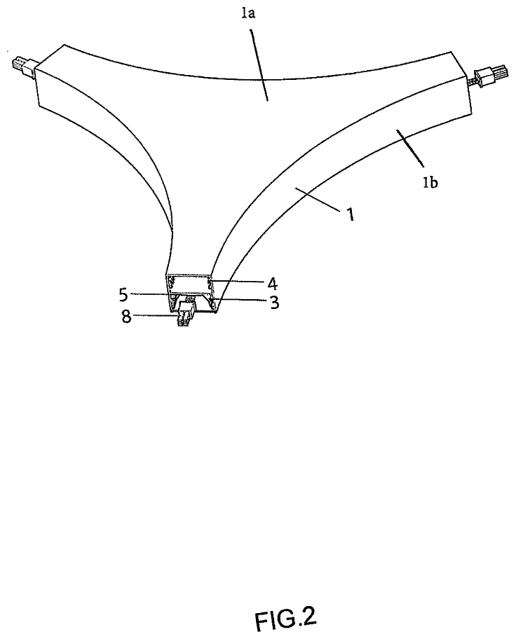

FIG. 1 illustrates a bottom view of the triangular module. A triangular housing 1 is illustrated with lens 2. Two compartments inside of the housing are shown in FIG. 1. The two compartments are separated by LED board 5. Reflectors 3 also point downwardly at an angle to reflect the light downwardly and are placed against the inside wall of the lower compartment at an angle to reflect the light downwardly. The housing 1 has curved sidewalls and open ends in between the sidewalls. Plug 8 can be placed at each of the open ends, and in electronic communication with the LED board 5. FIG. 2 illustrates the top view of the triangular module.

The triangular module can be connected at each end to another module or an end cap. Light from LED sources 6 leaves the lens through the lower compartment. The upper compartment can be used for attaching the triangular module to a support. Plug 8 can be used to plug the LED board 5 to a source of power, which can be the next adjoining module.

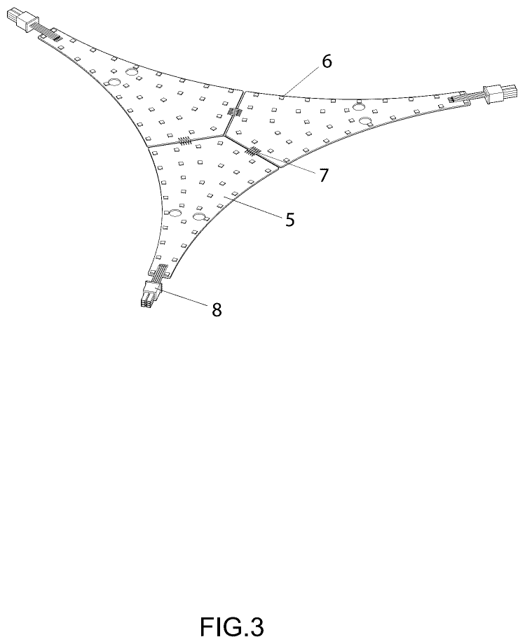

FIG. 3 illustrates a bottom view of the LED board 5, which in this is made by three boards connected to each other with connector 7. Connector 7 can also transfer power. A plurality of LED light sources 6 are places throughout the LED board 5. Plug 8 is placed at each end of the ends of the housing 1.

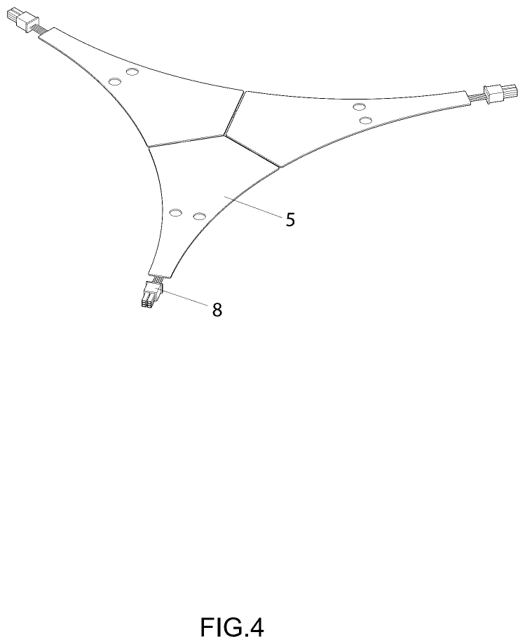

FIG. 4 is a top-view of the LED board 5. The top of the LED board 5 forms the bottom of the upper compartment. Each of the three boards that are connected to each other have a plug 8 for delivering power.

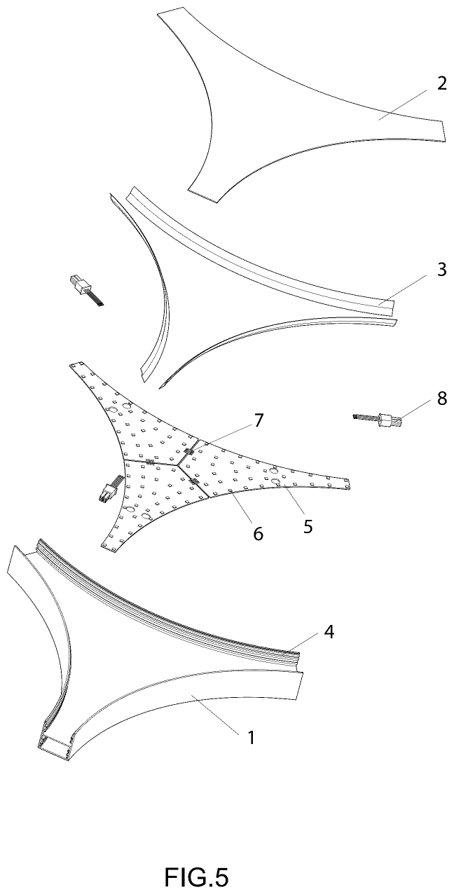

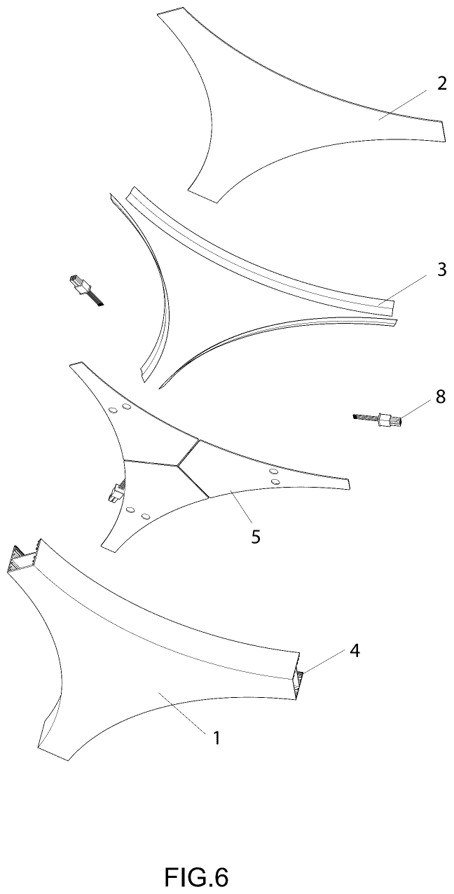

FIGS. 5 and 6 illustrate an exploded view of the triangular module. Housing 1 can be in the form of a tray with a bottom portion and walls, and with open ends. The walls of the housing 1 in this case can be curved. In other embodiments, the walls can be straight. The LED board 5 is placed in the housing in such configuration to create two compartments. The bottom compartment is sealed in such a way so that the light from the LED light sources 6 does not leak upwardly. The top compartment can be used for attaching housing 1 to a ceiling or wall. Reflectors 3 are placed against each sidewall in the bottom compartment at an angle. The reflectors 3 reflect the light downwardly. Lens 2, which can be a transparent or translucent glass or plastic (synthetic) material, is placed below the module and under the lower compartment. Light from the LED light sources 6 leaves the lower compartment through the lens 2. The triangular module can be connected at three ends, and each end has a plug 8 for attaching to the next module or an actual source of power. The modules can be attached to each other with the sidewalls and lens 2 aligned with each other (alignment within less 0.5 inches, or less than 02 inches), and without use of endcaps.

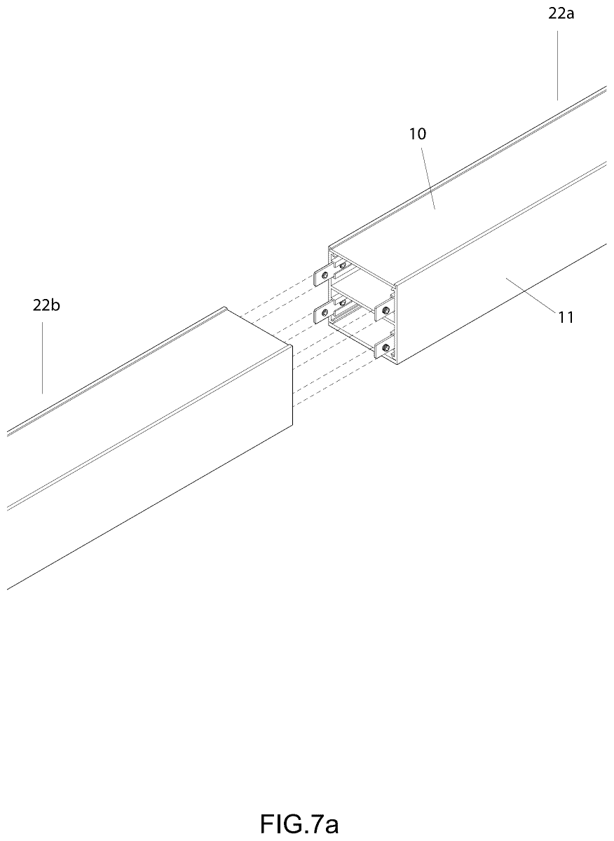

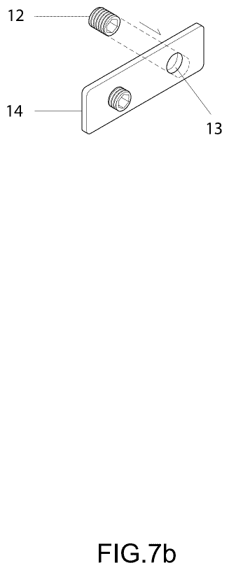

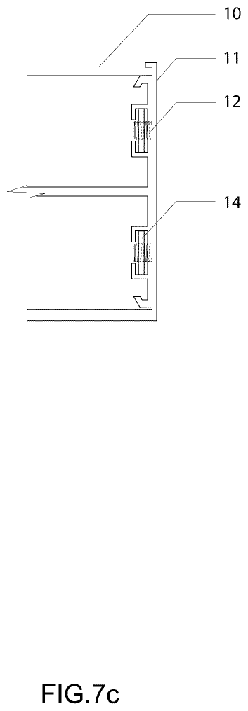

FIGS. 7a, 7b, and 7c illustrate connecting two linear modules together. The linear modules 22a, 22b can be connected with brackets 14 to each other. The bracket 14 can have two openings 13, with each opening 13 configured to receive a stopper 12. The bracket 14 (FIG. 7b) can be placed in track 4 (without a track in other embodiments) on the walls 11 or top 10 of the housing. Track 4 stabilizes bracket 14. Bracket 14 can have a stopper 12 that works with a spring mechanism. Stopper 12 can fit into a depression (hole) 13 on the wall 11 or top 10 of the housing to keep the bracket in place. Bracket 14 can be removably attached to two adjoining pieces, by placing it in the track 4 and having the stopper 12 “click” into the depression (FIG. 7c). The two parts are removably attached to each other, can be taken apart from each other by force.

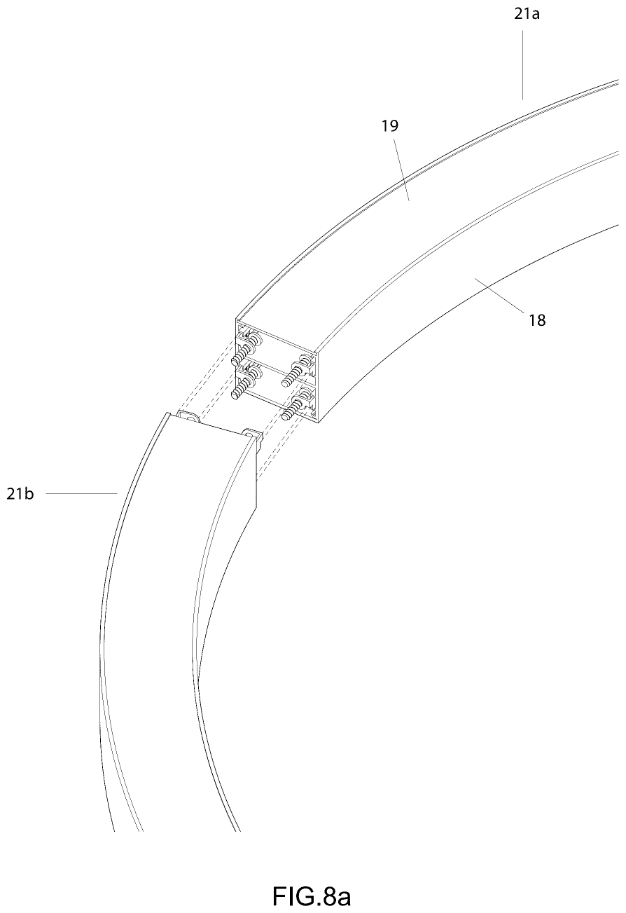

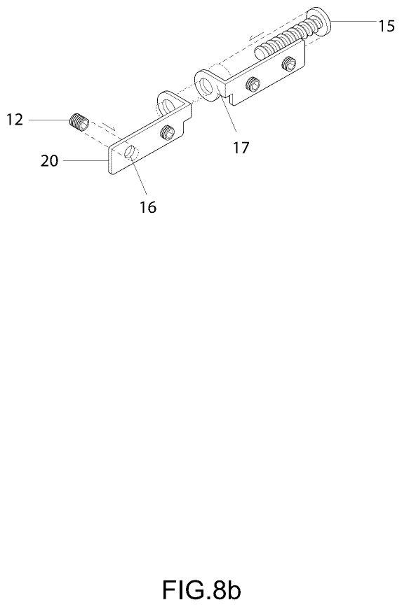

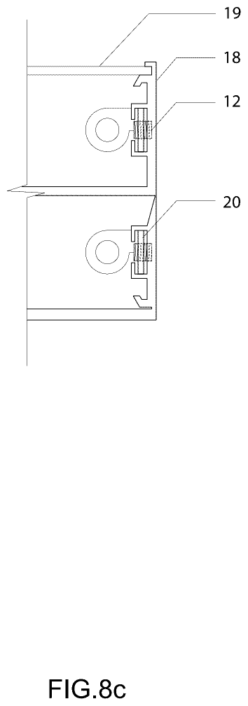

FIGS. 8a, 8b, and 8c illustrate connecting two curved modules (21a, 21b) with a bracket 20 that have complementary fastener openings 17. Each bracket 20 is placed in a track and attached to the walls 18 or top 19 of the housing with stoppers 12. One end of the bracket 20 has a fastener opening 17, in this case a circular opening 17. The two of the brackets 20 are placed next to each other and fastened with a single screw (fastener) 15 to connect the two brackets 20 together.

FIG. 9 illustrates a three-dimensional connection of the different module pieces. Circular module 30 can be one or more pieces that connect to make a circle. Circular module 30 can have a missing portion to accept a portion of a transitional module, such as module 31. The module 31 which has a straight and a curved portion, and make a portion of the circle. Modules 30 and 31, can be put on a support, to create a table. Module 32 has a curved and a straight portion and can be configured to connect a module on the ground and with an elevated horizontal module. Module 33 can be a straight portion that is placed on a depression on the ground and strong enough to be stepped on. Module 34 can be a straight piece that can be attached vertically to a wall or hung from a ceiling. Module 36 can be made from one or more circular modules or modules that are only partially circular. Modules 40 and 35 are circular modules with a missing portion to receive a portion of a transitional module that fills the missing portion.

Module 41 is configured to make a transition from vertical to horizontal, which a curved body and ends that are perpendicular to each other. Module 42 is configured to make a shift horizontally or vertically in the same plane, with the body shifting sideways and the ends having an angle in relation to each other. The module ends can have angles of zero to 180 degrees relative to each other, and be in the same plane or different plane.

A triangular module 1 with curved sidewalls can act as a transition for each circular piece. The triangular module 1 forms part of the circle and connects with another module, such as a straight or triangular module. A curved module 32 can be used to transition from completely vertical position to a completely horizontal position, and can have two ends that are parallel to each other. The curved module 32 is optimal for transitioning from a wall to a ceiling.

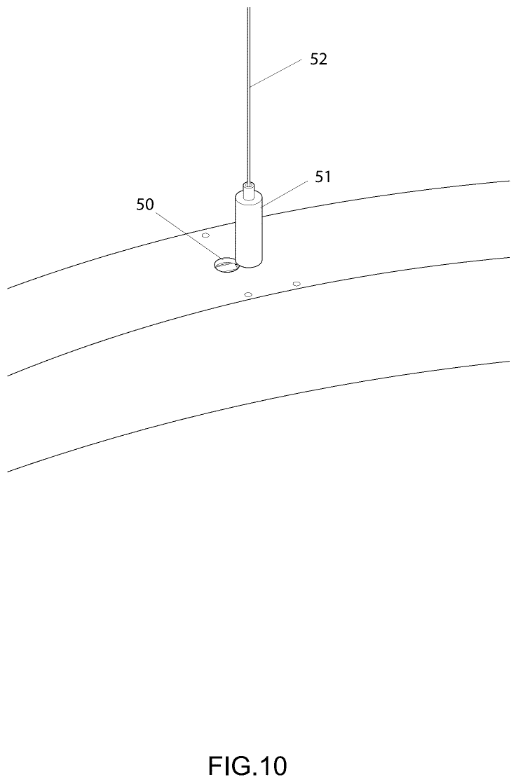

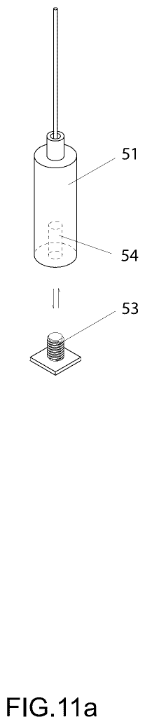

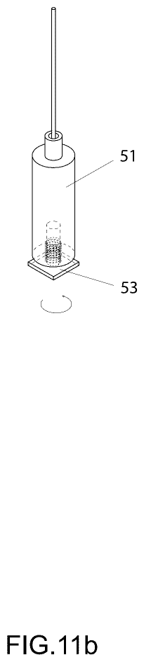

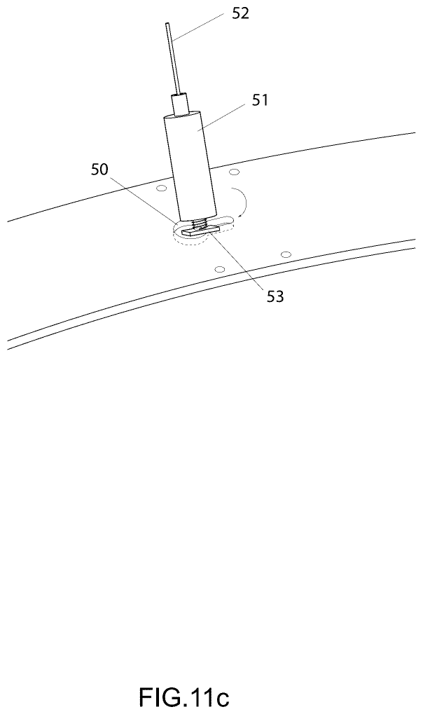

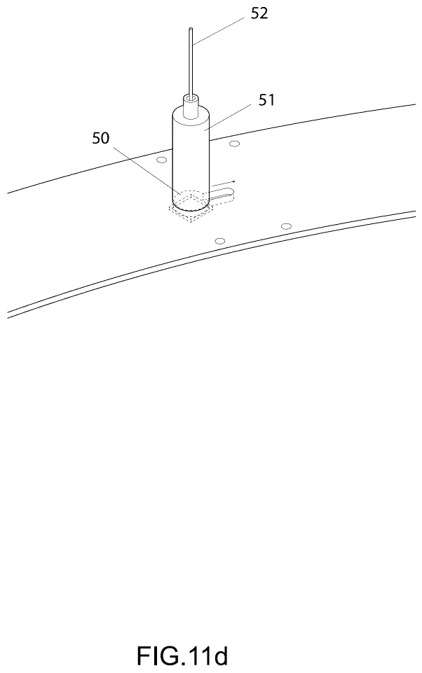

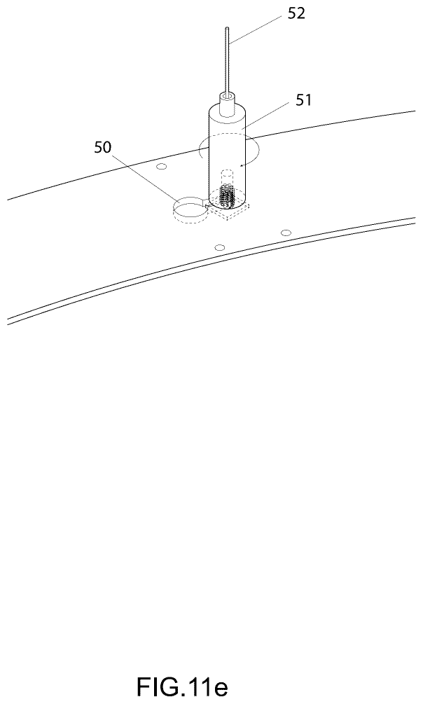

The modules can be suspended from the ceiling (FIGS. 10, 11a, 11b, 11c, 11d, and 11e). The top of the modules can have an opening for attachment of a fastener or another mechanism. The top of the modules can have an opening and a track, where a fastener or a snap member is snapped into a receiver that is attached to the ceiling with a wire.

The modules attached to the ceiling can be partially or completely circular 40. The module 40 can also be curved with two straight ends 38, configured to change the height of the modules in relation to the ceiling/ground. Module 38 has a first and second straight ends that connect at different heights of the ceiling to other modules, and have parallel ends. Module 37 is a semi-circular piece that changes the direction of lighting depending on the next module that is added. An end cap can be added to the last module (FIG. 9).

FIGS. 10, 11a, 11b, 11c, 11d, and 11e illustrate attaching the modules to the ceiling with wire 52. Wire 52 can be attached to holder 51, which is attached to an opening 50 in the top of the module. The opening 50 can have a large circular and a smaller straight portion. The base 53 is attached to the holder 51 with a fastener, and goes inside of the fastener opening 54. The top of the module can be placed in between the base 53 and holder 51. The larger portion of the opening 50 can be used for the initial placement of the base 53. The base 53 can be moved to the smaller straight section of the opening 50 and fastened.

### Optics & Performance

This item's high-efficiency LED optical system includes a precision-cut acrylic lens with a smooth frosted finish for glare-free, even illumination and reflective sidewalls that help distribute the LED light evenly across the acrylic surface. The lens features a snap-in design that fits securely into the groove of the fixture's body, making it easy to remove for access to the LED driver and LED board. This SOUL-LED fixture can be customized into various shapes by assembling different angles and degrees to meet diverse architectural needs.

### Construction

Body constructed from up to 90% recyclable, extruded architectural-grade 6063 aluminum with a minimum wall thickness of 0.075″, to ensure durability and sustainability. Lenses are made from twin-layered, extruded high-impact acrylic, with a maximum single length of 7 ft.

### Distribution Patterns & Diffuser

Features an optically extruded, high-impact acrylic lens for a uniform, smooth illumination with reduced glare and precise light output control. Lens designed to snap securely into the housing and integrate seamlessly with the fixture, to ensure a refined and clean appearance

### CRM Installation

Housing connections will feature a joint bracket and a male/female connector for electrical connections.

### Support Cable/Feed

For the suspended mount version of SOUL, aircraft cable mounting points are available at intervals of 2, 4, 6, 8, and 11 feet centered along the fixture's length, with the mounting points positioned a ½ inch from each end of the fixture or run. Adjustable cable mounts can be made to align with the existing mounting points, as per the installation instructions, and allow for adjustment across the fixture's width for balance. The minimum suspension height from the ceiling to the top of the fixture is 4 inches, and the fixture can be leveled at the mounting bracket. All sections come pre-wired with push-in connectors for quick setup, and the fixtures can be connected in a straight, continuous run using the supplied alignment brackets, pins, and internal joiners.

### Led Dynamic Platform Options

Our advanced LED board is designed for superior output, efficacy, and reliability. Featuring a high Color Rendering Index (CRI) of 95, these LEDs provide exceptional color accuracy and vibrancy. With a remarkable lifespan of L70 at over 100,000 hours (TM-21), you can trust in their long-lasting performance. Enjoy consistent color with variations within 2-Step MacAdam ellipses. Available in a range of correlated color temperatures (CCT) including 3000K, 3500K, 4000K, 5000K, and 6500K these LEDs meet diverse lighting needs.

### Dimming & Driver Information DIM10

0-10V dimming on either MVOLT 120, 277. Dimmable down to 1% of initial lumens, standard. DIMTR—Triac & Electronic low voltage dimming. LUTH—Lutron LDE1 Hi-Lume Eco System with Soft Fade to Black dimming technology. ELDO10.1—Eldo LED SoloDrive 0-10V. Dimming down to 0.1%. Linear dimming curve. Eldo DALI—DALI DT6, DT8 dimming down to 1%. ELDODMX.1—Eldo LED PowerDrive dimming down to 0.1%. BLE—Luminaires may be controlled, grouped, scheduled or placed in scenes and or zones Via Cassambi Bluetooth 4.0 App.

What is claimed is:

1. A modular lighting system comprising:
a. a modular housing with a top and sidewalls, and open ends in between the sidewalls;
b. an LED board place inside of the modular housing;
c. a plurality of LED light sources placed on the LED board, the LED light sources facing downwardly; and
d. a lens placed below the LED board;
wherein the housing is configured to attach to one or more additional modular housings to create a lighting fixture with two- or three-dimensional shape;
wherein a top of the housing has an opening for attachment to a ceiling by a wire.

2. The modular lighting system of claim 1, wherein the modular housing is triangular, with curved sidewalls and open ends between the sidewalls.

3. The modular lighting system of claim 1, wherein the lighting system comprises at least three modules, with two of the modules configured to be attached to the ceiling in a horizontal orientation.

4. (canceled)

5. The modular lighting system of claim 1, wherein the module has two internal compartments, above and below the LED board.

6. (canceled)

7. The modular lighting system of claim 1, wherein the housing has a track inside for attachment to a bracket.

8. The modular lighting system of claim 1, wherein the end of one module is connected to another end of another module in such configuration that the modular housing and lens of the two modules align.

9. The modular lighting system of claim 8, wherein compartments inside of the housing formed below and above the LED board continue from one module to another without presence of an end cap.

10. (canceled)

11. A modular light system comprising:
a. a housing with a top, and two or more sidewalls;
b. an LED board placed inside of the housing, the LED board creating an upper and a lower compartment;
c. a plurality of LED light sources placed on the LED board in the lower compartment;
d. one or more openings in between the sidewalls;
e. a lens placed below the LED board for light to leave the lower compartment; and
f. one or more plugs for carrying electricity to the LED board, the plugs placed at the ends;
wherein the module is configured to be attached to another module of same or different shape.

12. The module of claim 11, further comprising a track on inside of the sidewalls for receiving a bracket.

13. The module of claim 11, wherein the housing is triangular, with three sidewalls and three openings at the ends in between the sidewalls.

14. The module of claim 13, wherein the triangular housing has curved sidewalls, at least one of the curved sidewalls configured to form part of a circle.

15. The module of claim 11, wherein the triangular housing has curved sidewalls, at least one of the curved sidewalls configures to form part of a circle.

16. The module of claim 11, wherein the housing has a curved body with straight ends that are parallel to each other.

17. The module of claim 11, wherein the housing has two ends, the two ends perpendicular to each other.

18. The module of claim 11, wherein the housing is S, O, or U shaped.

19. A modular lighting system comprising:
a. a housing with top, and two or more sidewalls;
b. an LED board placed inside of the housing, the LED board creating an upper and a lower compartment;
c. a plurality of LED light sources placed on the LED board in the lower compartment;
d. one or more openings in between the sidewalls;
e. a lens placed below the LED board for light to leave the lower compartment; and
f. one or more plugs for carrying electricity to the LED board;
g. a plug for making an electric connection placed at one or more the ends; and
h. a track on inside of the sidewalls for receiving a bracket;
wherein the module is configured to be attached to another module of same or different shape.

20. The module of claim 19, wherein the housing is configured to attach to another housing without an end cap.

21. A modular lighting system comprising:
a. a modular housing with a top and sidewalls, and open ends in between the sidewalls;
b. an LED board place inside of the modular housing;
c. a plurality of LED light sources placed on the LED board, the LED light sources facing downwardly; and
d. a lens placed below the LED board;
wherein the housing is configured to attach to one or more additional modular housings to create a lighting fixture with two- or three-dimensional shape;
wherein the modular housing is triangular, with curved sidewalls and open ends between the sidewalls.
